(19) United States
(12) Patent Application Publication
(10) Pub. No.: US 2022/0259098 A1
(43) Pub. Date: Aug. 18, 2022

(54) Method For Producing a High Concentration Reactive Quicklime Slurry With Antiscalant Properties

(71) Applicant: S.A. Lhoist Recherche et Developpement, Ottignies-Louvainla- Neuve (BE)

(72) Inventors: Deborah Ballard, Fort Worth, TX (US); Kirsten Ballard, Fort Worth, TX (US)

(73) Assignee: S.A. Lhoist Recherche et Developpement, Ottignies-Louvainla- Neuve (BE)

(21) Appl. No.: 17/673,346

(22) Filed: Feb. 16, 2022

Related U.S. Application Data
(60) Provisional application No. 63/150,407, filed on Feb. 17, 2021.

(51) Int. Cl. C04B 2/06; C04B 24/10

(52) U.S. Cl. CPC C04B 2/06; C04B 2103/0082; C04B 24/10

(57) ABSTRACT

A method is shown for forming a high solids reactive lime slurry from quicklime. The timely addition of a carbohydrate and antiscalant polymer to slaking water provides desirable degree of control over the rate of reaction in which the heat of reaction is moderated to ensure the antiscalant polymer remains intact, thereby producing a fine quicklime slurry with low and stable viscosity.

### BACKGROUND OF THE INVENTION

### 1. Field of the Invention

The present invention relates to high solids quicklime slurries and the method of their production, particularly without the use of gypsum as an additive for controlling the rate of the slaking reaction and particle size of the resulting slurry.

### 2. Description of the Prior Art

It is advantageous for quicklime slurries to be of high solids content for various reasons, including the fact that transportation and handling costs are reduced on a dry ton basis. At the present time, slurries derived from calcium oxide are either produced with gypsum added to the slaking water to retard the chemical reaction rate and increase the particle size by agglomeration, or are limited to approximately 20-30% solid content to avoid the formation of paste. If the sulfate compound (gypsum) is not added, the average particle size of the lime generated is very small, subsequently contributing to high viscosity or the formation of paste. When the sulfate compound is added, the particle size is greatly increased, but the gypsum addition also leads to a coarse, less reactive product, which is undesirable in most instances.

Another alternative to the use of gypsum to control the rate of the slaking reaction and particle size is to use a polymeric compound of a given type. For example, U.S. Pat. Nos. 7,718,085 B1, 7,897,062 B1 and 9,309,151 B2 teach the use of a “heat stable polymer” which is stable to “about 101° C.” (U.S. Pat. No. 9,309,151 B2). However, it would be desirable in some cases to be able to control the temperature of the slaking reaction to significantly less than 101° C. so that other, less exotic polymers, might be used for reasons of economy and other reasons.

A need exists, therefore, for a method for producing a high solids quicklime slurry which does not rely upon the addition of gypsum and consequently avoids the formation of a coarse, less reactive product.

A need also exists for such a high solids quicklime slurry which also has antiscalant properties which could prevent scale formation in the lime slurry system under consideration and consequently in customer piping and associated vessels.

A need also exists for such a high solids quicklime slurry which avoids a larger particle size which would make the slurry less reactive in many applications, which can lead to overdosing and the inability to tightly control the pH of the process.

### SUMMARY OF THE INVENTION

The foregoing needs are met with the method of the present invention. It has been found that, in the production of a lime slurry from quicklime, the timely addition of a carbohydrate and antiscalant polymer, preferably sorbitol and polycarboxylate polymer respectively, to the slaking water can control the slaking reaction to produce a finer particle size slurry (no crystal growth due to sulfate) with a low and stable viscosity.

It is important when producing high solids quicklime slurry to control the slaking rate and temperature profile of the reaction to achieve fine particles but also avoid creating paste. High temperatures during the slaking reaction can also destabilize the polycarboxylate polymer.

While carbohydrates have been used previously to modify viscosity in hydrated lime slurries, they have not, to our knowledge, generally been used in the slaking of quicklime slurries to control the rate of reaction, to be described more fully in the written description which follows.

In one preferred form of the invention, a method is shown for producing such a high concentration reactive quicklime slurry with antiscalant properties. A carbohydrate and antiscalant are first combined with water to form a batch of slaking water. Thereafter, a quantity of quicklime is added to the batch of slaking water to produce a resulting quicklime slurry. The quantity of carbohydrate present is precisely selected to control the slaking reaction and accompanying temperature profile of the slaking operation. The result is a finer particle size slurry than would be achieved with a gypsum slurry, the finer particle size slurry also being characterized as having a low and stable viscosity.

The preferred carbohydrate is selected from the group consisting of sugars and sugar alcohols. One preferred sugar alcohol is sorbitol.

The quantity of quicklime which is used is preferably at least partially prehydrated quicklime.

The antiscalant can be a polycarboxylate type antiscalant.

Instead of adding the carbohydrate and antiscalant to the slaking water and then adding the quicklime, the carbohydrate can first combined with the slaking water and the quicklime added, followed by adding the antiscalant after the slaking step.

Additional objects, features and advantages will be apparent in the written description which follows.

### BRIEF DESCRIPTION OF THE DRAWINGS

FIG. 1 is a graph of the heat rise over time for slurries having no additive, gypsum additive and the antiscalant/carbohydrate additive system of the invention.

FIG. 2 is a graph of the particle size distribution which is observed with the same comparative slurries as in FIG. 1.

FIG. 3 is a comparison graph showing the improved consumption and reactivity achieved through the slurries of the invention, as compared to a traditional gypsum slurry.

FIG. 4 is a graph of the dynamic viscosity comparing slurries containing no additive, a gypsum slurry and a slurry of the invention, respectively.

FIG. 5 is a graph showing the temperature profile of a slurry containing gypsum and a slurry of the invention, showing that similar temperature rises (profiles) are achieved with the slurries of the invention.

FIG. 6 is a graph which compares the dissolution rates of a quicklime slurry of the invention with a traditional gypsum and quicklime slurry.

### DETAILED DESCRIPTION OF THE INVENTION

The preferred version of the invention presented in the following written description and the various features and advantageous details thereof are explained more fully with reference to the non-limiting examples included and as detailed in the description which follows. Descriptions of well-known components and processes and manufacturing techniques are omitted so as to not unnecessarily obscure the principal features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

For purposes of the discussion which follows, it is important to understand the various formulatives referred to in the literature as “lime.” The term “lime” can encompass quicklime (calcium oxide—CaO), hydrated or at least partially hydrated lime (calcium hydroxide—Ca(OH)₂) or lime slurry.

Quicklime is manufactured by chemically converting limestone (calcium carbonate—CaCO₃) into calcium oxide in a high temperature kiln. Hydrated lime is created when quicklime chemically reacts with water and is generally in a powdered form. Lime slurry is a suspension of hydrated lime in water and can be formed from either hydrated lime or quicklime.

There are various ways to “slake” quicklime and form a lime slurry. Applicant's “Portabatch®” and “Permabatch™” equipment and processes are a common approach to batch slurry production.

Quicklime is added to water in a batch tank which is equipped with horizontal paddles for mixing.

The resulting slurries have a particle size distribution, d₅₀, value of around 10 to 20 μm. Gypsum may be added to increase the particle size in order to reduce the viscosity of the slurry. The solid content achieved is generally in the range of 30-40%. The d₅₀ and solid content are dependent on whether gypsum is added to the slaking water before the addition of the quicklime. If no gypsum is added, the d₅₀ is finer but the solids content is generally limited to about 20-30%, or it will become too thick and paste-like. Adding gypsum to the slaking water allows the solids content to reach the 30-40% range and achieve the 10-20 micron d₅₀ particle size. As briefly discussed in the “Background” section of the application, while these types of slurries may be suitable for many applications, there are other specific applications that require further refinements to this general type slaking process.

In the discussion which follows, the distribution of the particle sizes is measured by means of a laser granulometer; these distributions are characterized in terms of, for example, d₅₀, d₉₀ and d₉₈, interpolated values of the particle size distribution curve. The dimensions d₅₀, d₉₀ on and d₉₈ correspond to the dimensions for which respectively 50%, 90% and 98% of the particles are less than the said dimensions. The viscosity of these milks of lime is measured according to standard industry practice, as by the use of a “Brookfield DV III Rheometer” viscometer, for example, with spindle No 3 at 100 rpm. Where specific surface areas of the lime particles are being measured, these measurements are made according to the BET nitrogen adsorption measurement method. These measurements are all familiar to those skilled in the relevant lime production arts.

According to present industry practices, in order to further process these compounds and improve the ease with which they are handled, dry CaO or dry Ca(OH)₂ is often mixed with water to form an aqueous suspension, i.e., a slurry, sometimes called milk of lime. This fluid suspension of slaked lime, also referred to as hydrated lime (calcium hydroxide—Ca(OH), can include impurities, in particular silica, and magnesium oxide to the extent of a few percent. Such a suspension is obtained either by slaking quicklime (calcium oxide—CaO) with a large excess of water, or by mixing hydrated lime with water.

The resulting aqueous suspensions are often characterized by the concentration of the mass of the solid matter (% solids), the chemical reactivity of the slurry, and the distribution of the sizes of the particles in suspension (controlling in part viscosity). These characteristics determine, in part, the properties of the slurry, mainly its viscosity and its reactivity.

The reactivity of an aqueous calcium magnesium suspension is determined by the dissolution rates of the particles. It may be measured by injecting a small amount of the suspension in a large volume of demineralized water. This measurement, based on the recording of the time-dependent change in the conductivity of the resulting liquid phase, was developed for monitoring reactivity of lime milks intended for softening of drinking waters (v. Van Eckeren et al. Improved Milk-of-Lime For Softening of Drinking Water: the Answer to the Carry-Over Problem, In Aqua, 1994, 43 (1), p. 1-10).

The lime slurries preferred for purposes of the present invention are fine milk of lime slurries with high solids content and relatively low viscosity so as to be easily pumpable. Those skilled in the relevant arts will appreciate that it is sometimes difficult to achieve the desired balance between viscosity, solids content and reactivity in the resulting lime slurries. Variables that generally affect the quality of slaked lime are disclosed in J. A. H. Oates—“Lime and Limestone” (pages 229-248) as well as in Boynton—“Chemistry and Technology of Lime and Limestone” (pages 328-337).

Some of the known commercial technologies for producing lime slurries having high solids contents include the following:

For example, it is known to increase the solids content of the milk of lime by adding a dispersing agent, in the presence of a small quantity of an alkaline metal hydroxide (U.S. Pat. Nos. 5,616,283, 4,849,128, and 4,610,801). This method of preparation makes it possible to achieve concentrations of dry matter greater than 40 wt % based on the total weight of the milk of lime, with a viscosity less than 1200 mPa·s.

It is also known to increase the solids content in the suspension, while limiting the increase in viscosity, by incorporating hydrated lime having a coarser particle size or by slaking quicklime under conditions favorable to the growth of the grains; for example, by limiting the increase in temperature during slaking and by adding sulfate additives such as gypsum, etc. (U.S. Pat. No. 4,464,353).

The present method produces a high concentration reactive quicklime slurry with antiscalant properties, without the addition of gypsum or other sulfates. In the method of the invention, a carbohydrate and an antiscalant are combined with a source of water to form a batch of slaking water.

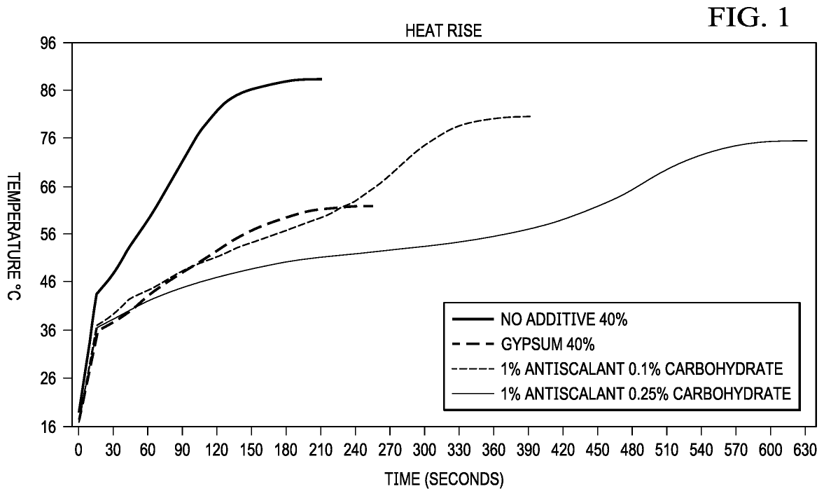

The quantity of carbohydrate is selected to “control the slaking reaction and accompanying temperature profile” of the slurry. In other words, the addition of the carbohydrate is limiting the increase in temperature, as is clearly shown in FIG. 1, and discussed further hereafter. As the amount of carbohydrate (sorbitol) is increased from 0.1 to 0.25%, the time to reach ˜60 degrees C. is roughly doubled from ˜210 seconds to ˜420 seconds. In the latter case, the highest temperature reached is significantly lower than in the case of no carbohydrate additive. This lower temperature eliminates the need to have a more exotic and expensive “heat stable polymer” present, since the slaking reaction temperature stays below about 82 degrees C.

The carbohydrate used is preferably one selected from among sugars and sugar alcohols. For example, the following carbohydrates are suitable candidates, depending upon the application at hand, for lowering the viscosity of calcium hydroxide aqueous slurries: aldoses, saccharides, disaccharides, polysaccharides and synthetic derivatives from such precursors, for example, glycerol, sorbitol, mannitol, gluconic, citric, isocitric, lactic, tartaric acids and salts thereof, dextrose, maltose, glucose, lactose, saccharose, maltotriose, maltotetraose, both alpha and beta glucoheptonic acids and salts thereof. Many of these are commercially available in syrup form, e.g., glucose syrup and corn syrup. One particularly preferred carbohydrate useful for purposes of the present invention is the sugar alcohol sorbitol. Sorbitol is commercially available from any of a number of known sources.

The sugar additive (sorbitol) is generally present between about 0.1 and 5 wt %, in particular between 0.1% and 3%, more particularly between 0.1% and 2% of quicklime.

The antiscalant which is used can be any of a number of commercially available products of the carboxylate type. Polycarboxylates are molecules or polymers that contain multiple carboxyl (COOH) groups which can form salts with metals and amine. The preferred agents are formatives of polymethacrylic acid along with the alkali metal salts thereof. The most preferred agents which are used are polycarboxylates, and the alkali metal salts thereof. A commercially available polycarboxylate agent is available as the FLOSPERSE™ line of polymeric dispersants manufactured commercially by SNF Floerger, One Chemical Plant Road, Riceboro, Ga. These polycarboxylates are described by the manufacturer as being (Meth) Acrylate homo and copolymers, i.e., either a homopolymer or a copolymer of (meth) acrylic acid with a number of different co-monomers. The carboxylic acid group in the polymer backbone may be neutralized with sodium, potassium, or ammonium hydroxides to give the corresponding salts.

The FLOSPERSE™ product line contains both homopolymers as well as specialty copolymers of different compositions and various levels of molecular weights (2,000 to 100,000). The properties of these specialty copolymers can be engineered by properly selecting the monomers and their relative compositions and through choice and control of the polymerization process. A particularly preferred FLOSPERSE™ agent is the FLOSPERSE™ 3000.

The polymeric antiscalant agents are preferably used in amount of less than 3% by weight based on the weight of quicklime. Preferably, between 1 to 2% by weight of quicklime are used, and more preferably 1 to 1.5% of antiscalant is used based on the dry weight of quicklime.

We have found that when the carbohydrate is used in combination with the described polycarboxylate that there are at least two benefits over the use of either product alone. Firstly, a lower total quantity of total additive is required to achieve a low viscosity slurry. Secondly, the lower viscosity of the slurry is maintained for a far longer period of time. In this specification we refer to the aqueous slurry as having a low viscosity, and this means that the viscosity is sufficiently low to allow adequate flow properties for the metering of the slurries using conventional facilities. In the absence of an additional cellulosic thickener, the viscosity of an aqueous slurry would be typically less than 1000 cps at low shear rates. In addition to these advantages, the method of the invention achieves temperature control so that it is not necessary to use a “heat stable” polymer as the antiscalant, i.e., one which can withstand temperatures of about or in excess of 180° F. (82° C.) without losing the aforementioned capabilities.

In a typical batch slurry process, the aforesaid carbohydrate and antiscalant are first added to the water source in a batch container to form the slaking water. Then, a quantity of quicklime is added to the batch of slaking water to produce a resulting quicklime slurry. The quantity of carbohydrate present is selected to control the slaking reaction and accompanying temperature profile, to thereby produce a finer particle size slurry than would be achieved with a gypsum slurry, the finer particle size slurry also being characterized as having a low and stable viscosity.

In some cases, the preferred quantity of quicklime which is used may be at least partially prehydrated quicklime. For example, batches of the slurry of the invention were made at only 7% prehydrated quicklime. Another batch was 16% prehydrated. It may be possible to achieve higher solids concentration dependent on the degree of prehydration while still maintaining a desirable viscosity.

The resulting slurries thus prepared advantageously have a dynamic viscosity less than or equal to 1000 mPa·s, preferably less than or equal to 600 mPa·s. Under these conditions it is possible to obtain a suspension having solid matter contents greater than 25 wt %, and advantageously at or greater than 40 wt %, and/or d₉₈ granulometric dimensions of less than 20 microns, preferably equal to or less than 5 microns. For example, a slurry might be a 40 wt % solids slurry, with a viscosity of less than 600 mPa·s and a particle size distribution with a d value of −5-10 um μm and d₋₉₀ value of less than 90 sm.

### EXPERIMENTAL SECTION

In the preferred embodiment of the present invention, carbohydrate and an antiscalant are mixed in the slaking water prior to combining with calcium oxide. The preferred form of carbohydrate is sorbitol and the preferred form of antiscalant is a polycarboxylate.

### Example 1

In the lab four slurries were produced at a target of 40% solids. 585 g of quicklime was added to 1395 g of water to produce a 39.9% slurry named “No Additive”. The gypsum slurry was produced by adding 5.85 g of gypsum to 1395 g of water then stirring to dissolve. Then 585 g of quicklime was added to produce “gypsum slurry” at 40.03% solids.

For the “1% antiscalant 0.1% carbohydrate” slurry 0.836 g of 70% sorbitol and 5.85 g of Flosperse was added to 1395 g of water and allowed to mix. 585 g of quicklime was then added to produce a 41.1% solids slurry.

The “1% antiscalant 0.25% carbohydrate” slurry was made by adding 2.089 g of sorbitol 70% and 5.85 g of Flosperse to 1395 g of water and allowed to mix. 585 g of quicklime was then added to produce a 41.3% solids slurry.

The heat rise for each slaked batch was recorded and compared. The original test was with sorbitol at 0.25% first but due to the extra delay seen in the reaction temperatures, another sample at 0.1% was produced to more closely mimic the retardation rate seen with the gypsum curve. The heat rise curves are shown in FIG. 1.

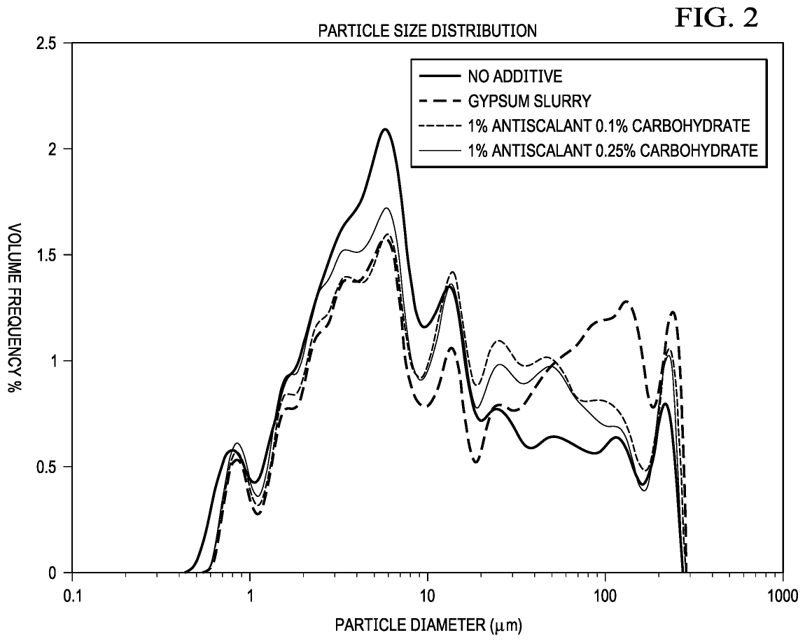

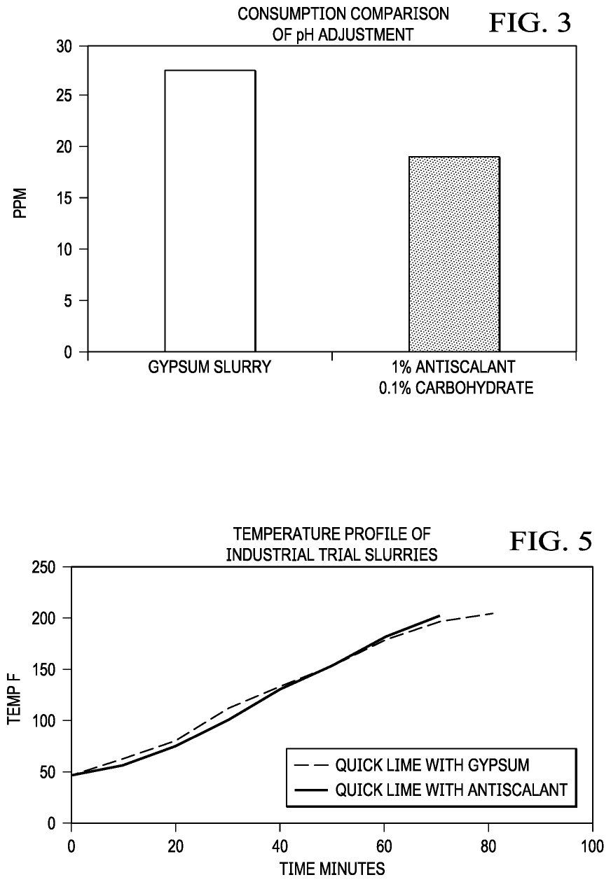

The particle size distribution of the slurries of the invention were also determined and compared to the gypsum slurries. FIG. 2 shows improved fineness for the sorbitol/Flosperse slaked slurries over the gypsum slaked slurry. This leads to improved consumption and reactivity as seen in comparative testing (see FIG. 3).

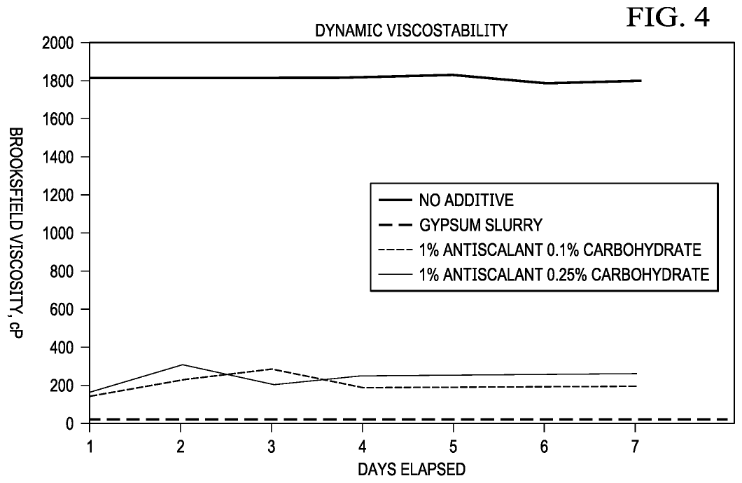

In comparing viscosity measurements (FIG. 4), it apparent that a 40% slurry cannot be made directly from quicklime without using some sort of additive without producing a paste.

### Example 2

In this series of experiments, 5.8 gallons of 70% Sorbitol solution and 50 gallons of Flosperse 3000 antiscalant were added to approximately 14,000 gallons of water and mixed for 15 minutes. Approximately 25 tons of quicklime was then added and allowed to mix and react for 1 hour. The heat rise data was compared to another industrial batch made with 0.67% gypsum added to 17,300 gallons of water and 30 tons of quicklime. Samples was pulled and measured for each slurry. The slurry with gypsum measured 42.4% solids and had a viscosity of 270 cP. The antiscalant and carbohydrate slurry measured 40% solids and approximately 430 cP at 100 RPM with a RV3 Spindle. The temperature profile again matched the profile seen with gypsum slaked quicklime slurries but had a d50 particle size distribution half that of the gypsum slaked slurry (6.57 μm and 14.1 μm respectively).

This industrial slurry sample (FIG. 5) had stable viscosity over a 14 day test period that included agitation unlike what is typically seen with other high solids quicklime slurries produced without gypsum.

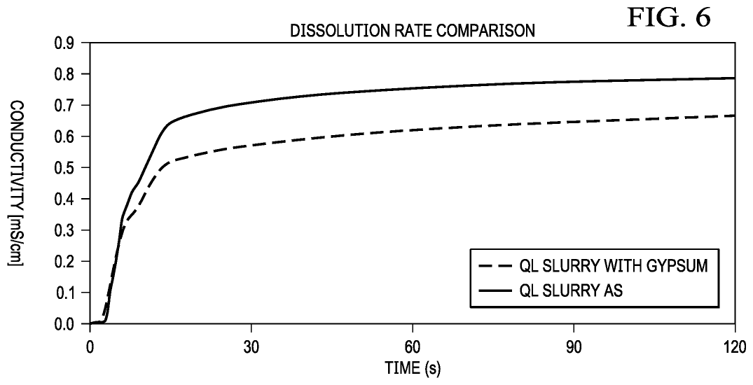

The quicklime slurry with antiscalant/carbohydrate of the invention, which was made with the same mother quicklime and same slaking equipment as the traditional quicklime slurry with gypsum, shows a faster dissolution rate (FIG. 6) with 90% reaction in 28 seconds compared to 48 seconds for the quicklime slurry with gypsum.

### Example 3

Approximately 15,740 gallons of water was added to a Portabatch® unit. 10 gallons of sorbitol or 0.14% w/w quicklime was added to the water along with 50 gallons of Flosperse™ 3000 (1.04%). This mixed for ten minutes then 19.6 tons of quicklime fines were added to the slaker. An additional 6.54 tons was then added to a truck and blown into the Portabatch®. Solids content was measured at 40.8% with a starting viscosity of 433 cP and an average 7 day viscosity of 392 cP.

### Example 4

In another example, 15,740 gallons of water, 50 gallons of Flosperse® (1.06%), 10 gallons of sorbitol at 0.15% were mixed for ten minutes before 25.63 tons of quicklime fines were added to the Portabatch® slaker. The resulting slurry had a starting viscosity of 486 cP and a 14 day average dynamic viscosity (mixed daily) of 482 cP.

### Example 5

A laboratory sample was created by adding 5.85 g of Flosperse® and 0.836 g of sorbitol to 1500 g of water. 585 g of quicklime fines were then added to the mixture and mixed for 30 minutes. The solids concentration measured 40.1% with an initial viscosity of 361 cP. The average of a 14 day dynamic viscosity was 505 cP.

An invention has been provided with several advantages. The invention replaces the need to add gypsum to the slaking water and instead employs a carbohydrate and antiscalant in the slaking water which does not coarsen the slurry like gypsum. In comparison to a normal quicklime slurry slaked with gypsum, the particle size distribution of the carbohydrate and antiscalant quicklime slurry is much finer. This allows for a much faster dissolution rate of the slurry and the ability to more tightly control pH adjustments. The antiscalant also acts to prevent scale formation in the lime slurry system and customer piping.

What is claimed is:

1. A method for producing a high concentration reactive quicklime slurry with antiscalant properties, the method comprising the steps of:
combining a carbohydrate and an antiscalant with a source of water to form a batch of slaking water;
adding a quantity of quicklime to the batch of slaking water to produce a resulting quicklime slurry, the quantity of carbohydrate present being selected to control the slaking reaction and accompanying temperature profile, to thereby produce a finer particle size slurry than would be achieved with a gypsum slurry alone, the finer particle size slurry also being characterized as having a low and stable viscosity.

2. The method of claim 1, wherein the carbohydrate is selected from the group consisting of sugars and sugar alcohols.

3. The method of claim 2, wherein the carbohydrate is sorbitol.

4. The method of claim 3, wherein the quantity of quicklime is at least partially prehydrated quicklime.

5. A method for hydrating calcium oxide to form a lime slurry, the method comprising the steps of:
substituting an antiscalant and a carbohydrate for gypsum as a slaking modifier, the quantity of carbohydrate being selected to control the heat of reaction of the slaking reaction and the accompanying temperature profile to thereby produce a finer more reactive high solids slurry that is visco stable for more than two weeks.

6. The method of claim 5, wherein the carbohydrate and antiscalant are first combined with a source of water to form a batch of slaking water and the quicklime is then added to the slaking water.

7. The method of claim 6, wherein the carbohydrate is first combined with the slaking water and the quicklime is then added, the antiscalant being added after the slaking step.

8. The method of claim 7, wherein the quicklime which is used is at least partially prehydrated quicklime.

9. The method of claim 8, wherein the quicklime is at least about 7% prehydrated.

10. The method of claim 8, wherein the quicklime is between about 7% and 16% prehydrated.

11. The method of claim 5 wherein the slurry is further characterized as having a solid content in the range from about 25% to about 60% by weight in the slurry.

12. The method of claim 5, wherein the slurry maintains a stable and pumpable viscosity of <1,000 mPa·s for up to one month or more.

13. The method of claim 5, wherein the particle size of the hydrated lime particles have a d₉₀ of 5 to 150 μm.

14. The method of claim 5, whererin the antiscalant is of the polycarboxylate type in an amount comprised between 0.5 and 5 wt %, based upon the total weight of the slurry.

15. The method of claim 5, wherein the carbohydrate is added in an amount of up to 2 wt % in weight of the hydrated lime.
